(19) United States
(12) Patent Application Publication
(10) Pub. No.: US 2026/0045736 A1
(43) Pub. Date: Feb. 12, 2026

(54) ELECTRICAL CONNECTOR FOR ELECTRICAL CONTACT IN HARSH CONDITIONS

(71) Applicants: Airbus SAS, BLAGNAC (FR); Airbus Operations GmbH, HAMBURG (DE)

(72) Inventors: Mihai Ioan ZECHERU, HAMBURG (DE); Frederic FORGET, BLAGNAC (FR); Antoine VAN DER LAAN, BLAGNAC (FR)

(21) Appl. No.: 19/289,700

(22) Filed: Aug. 4, 2025

(30) Foreign Application Priority Data
Aug. 6, 2024 (EP) 24306330.2

(51) Int. Cl. H01R 13/627; H01R 13/04; H01R 13/11; H01R 107/00

(52) U.S. Cl. CPC H01R 13/6277; H01R 13/04; H01R 13/111; H01R 2107/00; H01R 2201/26

(57) ABSTRACT

An electrical connector with a male part including a pin and a female part including a socket, in a connected position the pin is inserted into the socket. The connector also has a securing part on the socket. The securing made of a metamaterial and configured and arranged on the socket so that, in the connected position, when the electrical connector is subjected to a solicitation that tends to loosen the contact between the pin and the socket, it leads to an expansion of the securing part in a way that avoids loosening of the contact between the pin and the socket.

### CROSS-REFERENCES TO RELATED APPLICATIONS

This application claims the benefit of European Patent Application Number 24306330.2 filed on Aug. 6, 2024, the entire disclosure of which is incorporated herein by way of reference.

### FIELD OF THE INVENTION

The present invention relates to an electrical connector for improving electrical contact in harsh conditions, especially for an aircraft.

### BACKGROUND OF THE INVENTION

Commonly, an electrical system requires conductors such as wires to conduct electrical power and electrical connectors to connect said conductors to each other. Even though electrical connectors can come in a large variety of sizes and shapes, they generally comprise a female part (usually a socket) and a male part (usually a pin) which are configured to be connected together via conductive surfaces in order to form an electrical connection. If the contact between the conductive surfaces is not optimal, it may cause undesirable phenomena such as a premature wear of said conductive surfaces. The wear of contact surfaces can create local increase of the electrical resistance which can result in the apparition of hot spots. This phenomenon, called “fretting corrosion” is known to degrade the connectors over time and shorten their lifespan.

In aeronautics, the connectors are submitted to the in-flight conditions of the aircraft they are installed on, such as a passenger aircraft or a cargo plane. This causes vibrations which could affect the contact between the conductive surfaces of the connectors. Furthermore, the increasing need for higher electrical embedded power in the aircraft results in higher electrical currents that have to be conducted through the connectors. Both the vibrations and the increasing levels of currents are factors that can favor the apparition of contact fretting corrosion.

Solutions using contention parts to improve the contact between conductive surfaces of an electrical connector are known. In particular, document EP 4 181 322 suggests to use a shape memory alloy contention part to maintain the contact between a socket and a pin of a connector. However, the existing solutions either present opportunities for further improvement or require careful consideration for industrial-scale implementation.

Therefore, it is necessary to find other viable solutions to improve the contact between conductive surfaces in aircraft connectors, especially to counteract the contact fretting corrosion phenomenon.

### SUMMARY OF THE INVENTION

A purpose of the present disclosure is to overcome the drawbacks of the state of the art by proposing an electrical connector for connecting electrical conductors, especially in an aircraft, said electrical connector comprising at least a male part including at least one pin and a female part including at least one socket, the male part and the female part being configured to be movable between a non-connected position in which the male part is separated from the female part and a connected position in which the pin of the male part is inserted into the socket of the female part so as to form a contact between a first conductive surface of the pin and a second conductive surface of the socket thus providing an electrical connection, the electrical connector further comprises at least one securing part arranged on the socket.

According to the invention, the securing part is made of a mechanical metamaterial having a negative Poisson coefficient, said securing part being configured and arranged on the socket so that, in the connected position, when the electrical connector is subjected to a solicitation that tends to loosen the contact between the pin and the socket, it leads to an expansion of the securing part in a way that avoids said loosening of said contact between the pin and the socket.

The term “metamaterial” refers to a material made of architected artificial structures or composite materials configured to obtain particular physical properties that cannot be found in natural materials.

By making use of the electrical connector comprising the securing part made of a metamaterial according to the invention, it is possible to actively counteract thermal and/or mechanical solicitations to which said electrical connector could be submitted, thus improving the electrical contact between the conductive surfaces in harsh conditions such as high temperature, thermal dilation or vibrations and avoiding, or at least limiting, the contact fretting corrosion phenomenon.

Advantageously, the securing part has a shape complementary to the shape of the socket, in order to have the shape of the securing part that fits the shape of the socket.

In a preferred embodiment, the securing part has a ring shape and the expansion of said securing part intended to avoid the loosening of the contact between the pin and the socket corresponds to, at least, an extension in length of the securing part, longitudinally along the axial direction of said securing part.

Advantageously, the socket comprises a cylindrical body and a plurality of radially flexible tabs protruding axially from the body so as to define a tubular recess in which the pin is inserted in the connected position, the securing part being configured and arranged on the tabs in such a manner that the expansion of said securing part prevents the tabs from expanding radially.

In a first particular embodiment, the socket is provided with an annular groove arranged on a peripheral surface of the tabs, the securing part being arranged in said groove so that, when said securing part expands, the ends of the securing part come in contact with the sides of the groove thus preventing further expansion of said securing part.

In a second particular embodiment, the socket is provided with a conical portion arranged on a peripheral surface of the tabs, said conical portion extending longitudinally along the socket from the side of the body to the side of a free end opposite to the body, said free end comprising a shoulder defining one end of the conical portion, the securing part being arranged on the conical portion so that when said securing part expands, a first end of the securing part comes in contact with a conical surface of the conical portion on one hand and a second end of the securing part comes in contact with the shoulder on the other hand, thus preventing further expansion of said securing part.

In a particular embodiment, the male part includes a plurality of pins and the female part includes a plurality of sockets, the pins and the sockets being configured to be inserted, respectively, in one another in the connected position.

### BRIEF DESCRIPTION OF THE DRAWINGS

The disclosure herein, with its features and advantages, will emerge more clearly on reading the description given with reference to the appended drawings in which the same numerical references designate similar parts.

FIG. 1 schematically represents an electrical connector according to a particular embodiment of the invention.

FIG. 2A schematically represents a securing part in an idle state according to a particular embodiment of the invention.

FIG. 2B schematically represents the securing part from FIG. 2A in an expanded state.

FIG. 3A schematically represents a securing part in an idle state arranged in a groove of a socket of an electrical connector according to a particular embodiment of the invention.

FIG. 3B schematically represents the securing part from FIG. 3A in an expanded state.

FIG. 4A schematically represents a securing part in an idle state arranged on a conical portion of a socket of an electrical connector according to a particular embodiment of the invention.

FIG. 4B schematically represents the securing part from FIG. 4A in an expanded state.

FIG. 5 schematically represents a securing part in an idle state according to a particular embodiment of the invention.

FIG. 6 schematically represents a securing part in an idle state according to a particular embodiment of the invention.

### DETAILED DESCRIPTION OF THE PREFERRED EMBODIMENTS

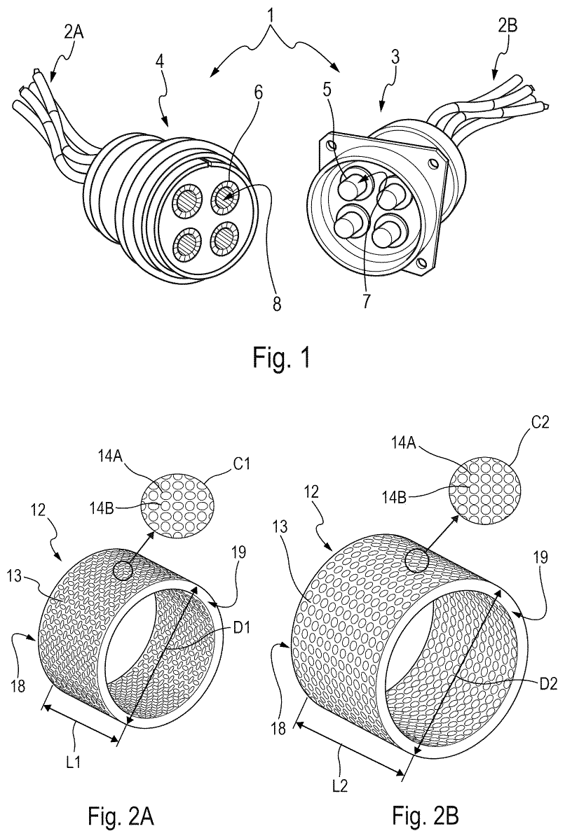

An electrical connector 1 (hereafter connector 1) according to the present invention is shown in particular embodiments from FIG. 1 to FIG. 4B. In these figures, the form and size of the connector elements are not limited and are designed in accordance with the application. As shown on FIG. 1, the connector 1 is intended to electrically connect systems (not shown) to each other, for example a power source and an electrical device, via electrical conductors 2A and 2B such as cables or cable harnesses. To do so, the connector 1 comprises a male part 3 and a female part 4 that are movable between a non-connected position in which they are separated from each other and a connected position in which they are connected so as to form an electrical connection between the conductors 2A and 2B.

More specifically, the male part 3 includes at least one pin 5 and the female part 4 includes at least one socket 6. The connector 1 comprises a single pin 5 and a single socket 6 or a plurality of them, as shown on FIG. 1 in a particular embodiment in which the connector 1 comprises four pins 5 and four sockets 6. For reasons of simplicity, the present description refers to a single pin 5 and a single socket 6, but the principle remains the same with a plurality of pins 5 and sockets 6.

The pin 5 and the socket 6 have complementary shapes configured to cooperate so that the pin 5 can be inserted into the socket 6. In this position, corresponding to the connected position, a first conductive surface 7 of the pin 5 is in contact with a second conductive surface 8 of the socket 6 in a manner that forms an electrical connection.

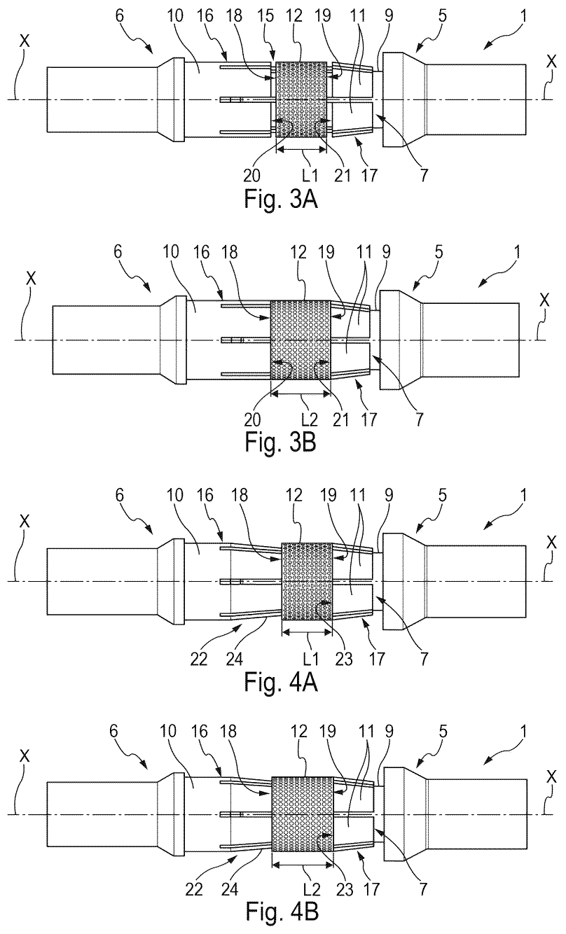

In a preferred embodiment illustrated from FIG. 3A to FIG. 4B, the pin 5 has a generally cylindrical shape with a cylindrical end 9 whose peripheral surface corresponds to the conductive surface 8 of the pin 5. Also, the socket 6 comprises a cylindrical body 10 and a plurality of tabs 11 protruding axially from the body 10. The tabs 11 are arranged so as to define a tubular recess suitable to receive the pin 5. The inner surface of said recess corresponds to the conductive surface 8 of the socket 6. Moreover, the tabs 11 are radially flexible to facilitate the insertion of the pin 5 and to exert an elastic force providing for gripping said pin 5 in the connected position. This ensures a proper holding of the pin 5 in the socket 6 and contributes to obtain a proper contact between the conductive surfaces 7 and 8.

In the connected position, the pin 5 and the socket 6 are coaxial in relation with a longitudinal direction X-X, as shown from FIG. 3A to FIG. 4B.

In other embodiments, the pin 5 and the socket 6 can have other complementary shapes than the ones described above, that are configured to cooperate with each other so as to form an electrical connection.

The connector 1 also comprises a securing part 12 which is illustrated on FIG. 2A and FIG. 2B in a particular embodiment. The securing part 12 is configured to be arranged on the socket 6 in order to ensure a proper contact between the pin 5 and the socket 6. Especially, as described further hereinafter, the securing part 12 is capable of avoiding a loosening of the contact between the pin 5 and the socket 6 when the connector 1 is subjected to solicitations that tends to loosen said contact.

In the present description, a solicitation that tends to loosen the contact between the pin 5 and the socket 6 corresponds to an effort, exerted directly or indirectly on the pin 5 and/or on the socket 6, leading to a reduction of the contact force maintaining the conductive surfaces 7 and 8 against each other. This reduction could favorize a displacement of the pin 5 in relation with the socket 6.

For example, such a solicitation can correspond to a thermomechanical stress induced by a temperature increase of the pin 5 and/or the socket 6, caused by a high intensity current flowing through the connector 1. Such a stress can induce thermal dilation contributing to opening the tabs radially and reducing the effort of the socket 6 on the pin 5. As a result, the contact between the conductive surfaces 7 and 8 is affected. Another example of such solicitations can be the vibrations the connector 1 can be subjected to according to the application considered, such as in-flight vibrations in an aircraft.

The securing part 12 is made of a metamaterial, that is to say a material made of architected artificial structures or composite materials configured to obtain particular physical properties that cannot be found in natural materials. They are usually materials made of assemblies of multiple elements fashioned from composite materials arranged in repeating specific patterns. A metamaterial can comprise one or more constituent materials, but it is the topology of its microstructure and the arrangement of its constituent materials, rather than said constituent materials themselves, that provide its particular properties. Indeed, the precise shape, geometry, size, orientation and arrangement of their microstructure pattern are specifically designed so as to obtain said particular properties. The metamaterial is designed to embed several material properties and functionalities in order to fulfill the design specifications and to simplify the architecture of the assembly. The metamaterial can also embed maintenance and retrofitability specifications.

The securing part 12 can be made of a metamaterial which is a mechanical metamaterial and/or a thermal metamaterial. A mechanical metamaterial exhibits unique mechanical properties (such as unique deformation) that cannot be found in a natural material and a thermal metamaterial exhibits unique thermal properties (such as unique thermal dilation). For example, a mechanical metamaterial could be a material whose structure provides a negative Poisson's coefficient. Such materials are known as auxetic materials or auxetics. A thermal material could be a material whose structure provides a negative coefficient of thermal expansion. With such metamaterials, it is possible to obtain, for instance, a part which exhibits lateral contraction when compressed and lateral expansion when stretched (which is against the properties of natural materials). In other words, when these metamaterials are deformed so as to expand in one direction, they simultaneously expand in other directions as well, which is the opposite to the behavior of natural materials.

The securing part 12 has a shape complementary to the shape of the socket 6, so that the shape of the securing part 12 fits the shape of the socket 6.

In the embodiment shown on FIG. 2A and FIG. 2B, the securing part 12 has a ring shape adapted so that the securing part 12 can fit on the socket 6 as explained hereinafter in different embodiments. Moreover, the securing part 12 comprises a wall 13 made of an auxetic material (a material with a negative Poisson's coefficient). More specifically, the wall 13 is provided with a plurality of openings 14A, 14B made through the wall 13. The openings 14A, 14B are arranged on the whole surface of the wall 13 in a regular grid pattern, each opening 14A, 14B being aligned with the openings 14A, 14B of the adjacent lines of the grid.

The securing part 12 may be made with a metamaterial having any shape of auxetic metamaterial (with a negative Poisson coefficient). Advantageously, the securing part 12 is made of an auxetic metamaterial with the lowest Poisson coefficient possible. In particular, the metamaterial of the securing part 12 fulfills the following conditions:
the metamaterial is usable in the temperature range the electrical connector is subjected to;
the metamaterial is strong enough to constrain the pin and the socket together;
the metamaterial is manufacturable (whatever the manufacturing process, for example additive manufacturing, milling, laser or water cutting . . . ).

The securing part 12 as described above can be made, for example, of one or more metallic material and/or a composite material. For instance, the securing part 12 may be made of metal, like aluminum or stainless steel.

Obviously, the present invention is not limited to the particular pattern of this embodiment and any other metamaterial structure with other pattern can be considered in other embodiments.

The securing part 12 may be made of metamaterial having a pattern of circular and/or elliptic and/or oblong and/or polygonal (square, rectangular, hexagonal . . . regular or irregular polygons) openings 14A, 14B. The securing part 12 may be made of metamaterial having a pattern of openings 14A, 14B having different shapes comprising curved and/or straight portions.

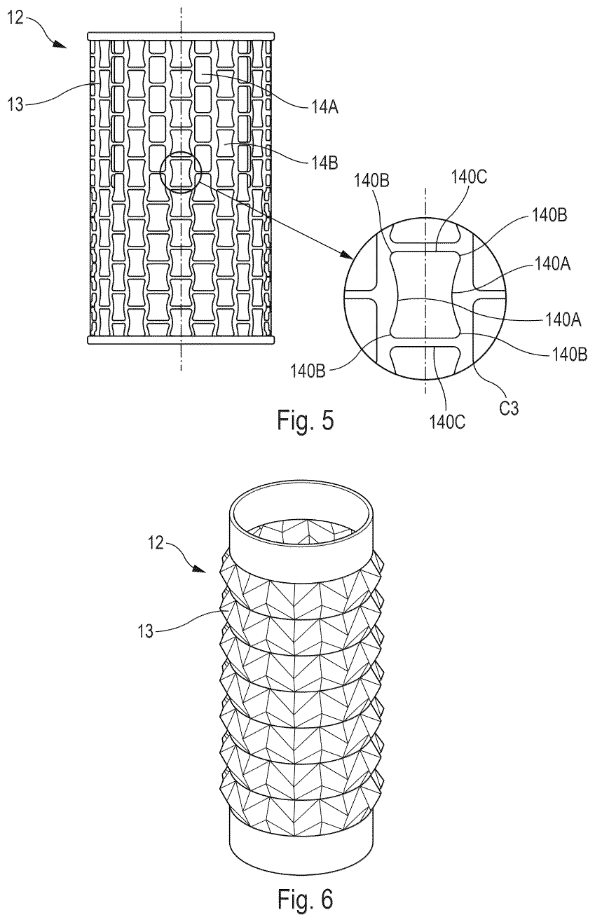

For instance, FIG. 5 illustrates a securing part 12 comprising a wall 13 made of an auxetic material and provided with a plurality of openings 14A, 14B made through the wall 13, the openings 14A being rectangular with rounded edges and the openings 14B comprising both curved portions 140A, 140B with different center or radius of curvature and straight portions 140C, as shown in the detailed view in circle C3.

For instance, FIG. 6 illustrates a securing part 12 comprising a wall 13 made of an auxetic material with a pattern of a kirigami structure (polygonal structure in three dimensions, with a regular pattern).

Moreover, even though the embodiments described in the present description relate to an auxetic material, the same principle would apply for other metamaterials like thermal metamaterials.

FIG. 2A illustrates the securing part 12 in an idle state, that is to say a state in which the securing part 12 is not subjected to external stress. In this state, the securing part 12 has a first length L1 and a first diameter D1. Moreover, in this idle state, all the openings 14A, 14B of the wall 13 have a generally oblong shape. However, as shown in the detailed view in circle C1, one opening 14A in two is oriented axially according to the axial direction of the ring shape of the securing part 12, while the other openings 14B are oriented radially. Thus, in the idle state, the openings 14A, 14B form a cross pattern.

FIG. 2B illustrates the securing part 12 in an expanded state. In this state, the securing part 12 has a second length L2 greater than length L1 and a second diameter D2 greater than diameter D1. The expanded state corresponds to a state in which the securing part 12 is submitted to thermal and/or mechanical stress leading to an increase of its diameter and/or length. This expanded state can occur, for example, if the temperature of the securing part 12 increases, which would lead to a thermal dilation and a diameter increase of said securing part 12. And since the securing part 12 is made of an auxetic material, this increase of its diameter would lead to an extension of its length as well.

In the particular example of FIG. 2B, all the openings 14A, 14B of the wall 13 have a generally circular shape as shown in the detailed view in circle C2. Moreover, for illustrative purposes, the expansion of securing part 12 shown on FIG. 2B has been exaggerated. The size difference between FIG. 2A and FIG. 2B is not representative of the actual size difference between the idle and expanded states.

The expansion properties of the securing part 12 explained above are used to avoid a loosening of the contact effort between the pin 5 and the socket 6 that could affect the electrical contact between the conductive surfaces 7 and 8. To do so, the securing part 12 can be arranged on the socket 6 according to the following embodiments.

In a first embodiment, illustrated on FIG. 3A and FIG. 3B, the connector 1 comprises a socket 6 provided with an annular groove 15 arranged on a peripheral face 16 of the tabs 11. In the cross section view in the longitudinal direction X-X, the groove 15 has a rectangular shape defined by a flat bottom and two parallel sides. The width or the bottom of the groove 15 is oriented along the longitudinal direction X-X. Moreover, this width is a bit larger than the length L1 of the securing part 12 and smaller than the length L2. The groove 15 has a diameter roughly equal to the diameter D1 of said securing part 12. The socket 6 also comprises a free end 17 opposite to its body 10 which has a conical shape in order to facilitate the passing of the securing part 12. This way, said securing part 12 can easily be arranged in the groove 15.

FIG. 3A illustrates the connected position when the connector 1 is not submitted to any solicitation that tends to loosen the contact between the pin 5 and the socket 6. In this situation, the pin 5 is inserted into the socket 6 which applies a regular elastic pinching force on said pin 5 in order to maintain it in position and ensure a proper contact between the conductive surfaces 7 and 8. Moreover, the securing part 12 is in its idle state which means it is resting in the groove 15 without applying any particular constraint on the socket 6.

FIG. 3B illustrates the connected position when the connector 1 is submitted to a solicitation that tends to loosen the contact between the pin 5 and the socket 6. As a non-limiting example, it corresponds to the case of a high intensity current flowing through the connector 1 that leads to an increase of the temperature of the pin 5 and the socket 6. Indeed, such an increase of temperature leads to a thermal dilation of the socket 6 that causes the tabs 11 to spread radially thus reducing the gripping force of said socket 6 on the pin 5.

In this case, the increased temperature of the socket 6 induces both a mechanical stress and a thermal dilation to the securing part 12, leading to an increase of its diameter. This means that the securing part 12 is moving from the idle state to the expanded state in which its length also increases. Since the width of the groove 15 is smaller than the length L2 of the securing part 12, it will block any further expansion of said securing part 12. Indeed, as shown on FIG. 3B, when the securing part 12 extends in length, both ends 18 and 19 of the securing part 12 will come in contact with, respectively, both lateral sides 20 and 21 of the groove 15.

When the expansion of the securing part 12 is blocked by the sides 20 and 21 of the groove 15, so is the thermal dilation of the socket 6 and the spreading of the tabs 11. In consequence, the temperature of the socket 6 can increase without causing any loosening of the contact between the pin 5 and the socket 6. On the contrary, the pin 5 will keep trying to expand due to thermal dilation, thus generating pressure on the socket 6 from inside the recess. Since said socket 6 cannot expand because of the securing part 12, this pressure will improve the contact between the conductive surfaces 7 and 8.

In a second embodiment, illustrated on FIG. 4A and FIG. 4B, the connector 1 comprises a socket 6 provided with a conical portion 22 arranged on the peripheral face 16 of the tabs 11. The conical portion 22 extends longitudinally along the socket 6 with its diameter decreasing in the direction of the free end 17. The conical portion 22 has a length greater than the length L2 of the securing part 12. Also, the largest diameter of the conical portion 22 (on the side of the body 10) is larger than the diameter D2 of the securing part 12.

Moreover, the socket 6 comprises a shoulder 23 arranged at said free end 17 and defining one end of the conical portion 22. The conical portion 22 is configured so that the securing part 12 can be arranged on it. When the securing part 12 is arranged on the conical portion 22, as shown on FIG. 4A, it is blocked on one hand by the shoulder 23 and on the other hand by a conical surface 24 of the conical portion 22.

FIG. 4A illustrates the connected position when the connector 1 is not submitted to a solicitation that tends to loosen the contact between the pin 5 and the socket 6. In this situation, the pin 5 is inserted into the socket 6 which applies a regular elastic gripping force on said pin 5 in order to maintain it in position and ensure a proper contact between the conductive surfaces 7 and 8. Moreover, the securing part 12 is in its idle state and the conical portion 22 is configured so that, in the idle state, said securing part 12 does not apply any particular constraint on the shoulder 23 and the surface 24 of the conical portion 22.

FIG. 4B illustrates the same situation as FIG. 3B when the connector 1 is submitted to a solicitation that tends to loosen the contact between the pin 5 and the socket 6, such as a thermal dilation due to a high intensity current flowing through the connector 1. In this situation, the same principle as the one of the first embodiment applies. The difference is that when the securing part 12 extends in length, the end 19 of the securing part 12 will come in contact with the shoulder 23 and the end 18 of the securing part 12 will come in contact with the surface 24. This way, the securing part 12 is blocked on one hand by the shoulder 23 and presses the socket 6 on the pin 5 by pushing against the conical surface 24 on the other hand. In consequence of this pressure, the tabs 11 are forced to tighten their grip on the pin 5, thus improving the contact between the conductive surfaces 7 and 8.

Of all the above, it appears that with the connector 1 comprising the securing part 12 made of a metamaterial, it is possible to actively counteract thermal and/or mechanical solicitations to which the connector 1 could be submitted, thus improving the electrical contact between the conductive surfaces in harsh conditions such as high temperature, thermal dilation or vibrations and avoiding, or at least limiting, the contact fretting corrosion phenomenon. As a consequence, the connector 1 contributes to make the increase of the amount of current that flows through said connector 1 possible, without worrying about the contact fretting corrosion phenomenon.

Although not exclusively, the connector 1 described above is particularly suited to be implemented in a flying vehicle, for instance in an aircraft such as a passenger aircraft or a cargo aircraft, or for instance in an eVTOL (electrical Vertical and Take-Off Landing) vehicle. The connector 1 can be used for connecting systems of the flying vehicle that require a great amount of electrical power, thus requiring high intensity currents to be conducted through connectors. It can also be used for the connections of the flying vehicle that are subjected to harsh in-flight conditions generating vibrations in the connectors. Indeed, these applications correspond to typical situations in which contact fretting corrosion phenomenon can occur.

The connector 1 makes it possible to easily avoid, or at least limit, the occurrence of contact fretting corrosion phenomena in these applications. Moreover, the connector 1 does not require a lot of modifications on existing connectors or having to change them for bigger and heavier ones.

Obviously, the connector 1 is not limited to be used in an aircraft and is suited to be implemented in a large variety of systems in many domains and applications.

The connector 1 comprising the securing part 12 made of a metamaterial as described above, provides many advantages, especially:
it makes it possible to actively avoid, or at least limit, the contact fretting corrosion on conductive surfaces 7 and 8, thus significantly reducing their premature wear;
it makes it possible to improve the electrical contact between the conductive surfaces 7 and 8;
it is a simple, cheap and light solution;
it is a generic solution that can easily be implemented on a large variety of connectors;
it makes it possible to increase the amount of current flowing through connectors without degrading them.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An electrical connector for connecting electrical conductors, the electrical connector comprising:
a male part including at least one pin; and
a female part including at least one socket,
the male part and the female part being configured move between a non-connected position in which the male part is separated from the female part and a connected position in which the at least one pin of the male part is inserted into the at least one socket of the female part so as to form a contact between a first conductive surface of the at least one pin and a second conductive surface of the at least one socket thus providing an electrical connection,
wherein the electrical connector further comprises at least one securing part arranged on the at least one socket,
wherein the at least one securing part is made of a mechanical metamaterial having a negative Poisson coefficient,
wherein the at least one securing part is configured and arranged on the at least one socket so that, in the connected position, when the electrical connector is subjected to a solicitation that tends to loosen the contact between the at least one pin and the at least one socket, the at least one securing part leads to an expansion of the securing part in a way that avoids the loosening of the contact between the at least one pin and the at least one socket.

2. The electrical connector according to claim 1, wherein the at least one securing part has a shape complementary to a shape of the at least one socket.

3. The electrical connector according to claim 1, wherein the at least one securing part has a ring shape and the expansion of the at least one securing part corresponds to, at least, an extension in length of the at least one securing part, longitudinally along an axial direction of the at least one securing part.

4. The electrical connector according to claim 3, wherein the at least one socket comprises a cylindrical body and a plurality of radially flexible tabs protruding axially from the cylindrical body so as to define a tubular recess in which the at least one pin is inserted in the connected position, and
wherein the at least one securing part is configured and arranged on the radially flexible tabs in such a manner that the expansion of the at least one securing part prevents the radially flexible tabs from expanding radially.

5. The electrical connector according to claim 4, wherein the at least one socket is provided with an annular groove arranged on a peripheral surface of the radially flexible tabs,
wherein the at least one securing part is arranged in the annular groove so that when the at least one securing part expands, ends of the at least one securing part come in contact with lateral sides of the annular groove thus preventing further expansion of the at least one securing part.

6. The electrical connector according to claim 4, wherein the at least one socket is provided with a conical portion arranged on a peripheral surface of the radially flexible tabs, the conical portion extending longitudinally along the at least one socket from a side of the body to a side of a free end opposite to the body, the free end comprising a shoulder defining one end of the conical portion,
wherein the at least one securing part is arranged on the conical portion so that when the at least one securing part expands, a first end of the at least securing part comes in contact with a conical surface of the conical portion and a second end of the at least one securing part comes in contact with the shoulder and, thus, prevents further expansion of the at least one securing part.

7. The electrical connector according to claim 1, wherein the male part includes a plurality of pins and the female part includes a plurality of sockets, each pin of the plurality of pins being configured to be inserted, in the connected position, in one of the sockets from the plurality of sockets.
